(19) United States
(12) Patent Application Publication
(10) Pub. No.: US 2020/0381725 A1
(43) Pub. Date: Dec. 3, 2020

(54) USE OF COBALT IN A LITHIUM RICH CATHODE MATERIAL FOR INCREASING THE CHARGE CAPACITY OF THE CATHODE MATERIAL AND FOR SUPPRESSING GAS EVOLUTION FROM THE CATHODE MATERIAL DURING A CHARGE CYCLE

(71) Applicant: Dyson Technology Limited, Wiltshire (GB)

(72) Inventors: Matthew Robert ROBERTS, Oxford (GB); Peter George BRUCE, Oxford (GB); Niccolo GUERRINI, Oxford (GB); Rong HAO, Shenzhen (CN); Francis Gachau KINYANJUI, Nairobi (KE)

(73) Assignee: Dyson Technology Limited, Wiltshire (GB)

(21) Appl. No.: 16/955,028

(22) PCT Filed: Dec. 18, 2018
(86) PCT No.: PCT/GB2018/053659

§ 371 Date: Jun. 17, 2020

(30) Foreign Application Priority Data
Dec. 18, 2017 (GB) 1721179.8

(51) Int. Cl. H01M 4/525; H01M 4/36; H01M 4/505; H01M 10/0525

(52) U.S. Cl. CPC H01M 4/525; H01M 4/366; H01M 2004/028; H01M 10/0525; H01M 4/505

(57) ABSTRACT

Use of cobalt in a cathode material of the general formula: Li (4/3-2x/3-y/3) NiₓCo_{y}Mn(2/3- x/3-2y/3)O₂ for increasing the charge capacity of the material and for suppressing gas evolution from the cathode material during a charge cycle.

### REFERENCE TO RELATED APPLICATIONS

This application is a national stage application under 35 U.S.C. 371 of International Application No. PCT/GB2018/053659, filed Dec. 18, 2018, which claims the priority of United Kingdom Application No. 1721179.8, filed Dec. 18, 2017, the entire contents of each of which are incorporated herein by reference.

### FIELD OF THE DISCLOSURE

The present invention relates to a set of electroactive cathode compounds. More specifically the present invention relates to the use of a set of high capacity lithium rich MC compounds.

### BACKGROUND OF THE DISCLOSURE

Conventional lithium ion batteries are limited in performance by the capacity of the material used to make the positive electrode (cathode). Lithium rich blends of cathode materials containing blends of nickel manganese cobalt oxide offer a trade-off between safety and energy density. It is understood that charge is stored in the transition metal cations within such cathode materials. It has been suggested that the capacity, and therefore energy density, of cathode materials could be significantly increased if charge could be stored on anions (for example oxygen) reducing the need for such high amounts of heavy transition metal ions. However, a challenge remains to provide a material that can rely on the redox chemistries of both the anions and cations to store charge, and withstand charge/discharge cycles without compromising the safety of the material, or causing undesired redox reactions which would break down the material.

### SUMMARY OF THE DISCLOSURE

In a first aspect, the present invention relates to the use of cobalt in a cathode material of the general formula:

$${Li}_{( \frac{4}{3} - \frac{2 x}{3} - \frac{y}{3} )} {Ni}_{x} {Co}_{y} {Mn}_{( \frac{2}{3} - \frac{x}{3} - \frac{2 y}{3} )} {O}_{2}$$

for increasing the charge capacity of the material.

In a second aspect the present invention relates to the use of cobalt in a cathode material of the general formula:

$${Li}_{( \frac{4}{3} - \frac{y}{3} )} {Co}_{y} {Mn}_{( \frac{2}{3} - \frac{2 y}{3} )} {O}_{2}$$

for increasing the charge capacity of the material.

In examples of the use x is greater than or equal to 0 and less than 0.2; and y is greater than 0.12.

It has been found that a compound with an improved capacity can be achieved by reducing the amount of excess lithium and increasing the amount of cobalt and/or nickel. The particular compound as defined above exhibits a significantly large increase in capacity due to the degree of oxidation of cobalt and/or nickel and also the oxidation of the oxide ions within the lattice. Without wishing to be bound by theory, it is understood that the presence of a particular amount of cobalt and/or nickel substitution enables oxygen redox activity and thereby improves the electrochemical capacity of the material.

In addition, the compounds of the present invention exhibit improved stability during electrochemical cycling when compared to the transition metal substituted NMC lithium rich materials of the prior art. The evolution of molecular oxygen is ubiquitous with third row lithium-rich materials transition metal oxides where lithium has been exchanged for some of the transition metal ions (Li₁₊ₓM₁₋ₓO₂, where M is Ti, V, Cr, Mn, Fe, Co, Ni, Cu or Zn). These materials generally rely on oxygen redox to improve their charge capacity properties. Homogenous materials can suffer from molecular oxygen escaping from the crystal structure during cycling due to redox of the oxide anion. In turn, this reduces the capacity and useful lifetime of the material.

It is understood that when the charge imbalance caused by the removal of a lithium ion is balanced by the removal of an electron from the oxygen anion the resulting oxygen anion is unstable which results in undesired redox reactions and the evolution of molecular oxygen gas during charge cycling. Without wishing to be bound by theory, it is understood that the specific cobalt and/or nickel content in the material relative to the lithium content avoids under-bonding within the lattice such that each oxygen anion is still bonded to ˜3 cations. The chemical approach of the present invention tunes the structure of the lattice using specific amounts of transition metals which improves capacity of the material and the increases the stability of the material over a number of charge/discharge cycles.

In examples of the invention, x is 0. In other words, the nickel content of the compound is effectively zero. In this example y (i.e. the cobalt content) is greater than 0.12. In an even more particular example y may be equal to or greater than 0.2. It has been demonstrated that capacity of the material is significantly improved when y is equal to or is greater than 0.2. In addition y may be equal to or less than 0.4. It is understood that the capacity of the material declines to expected levels above this threshold. It has been demonstrated that improved capacity is achieved when y is 0.3. More specifically, the value of y could be said to be greater than 0.2 and equal to or less than 0.4. More specifically, the value of y could be said to be greater than 0.2 and equal to or less than 0.3. In two particular examples, y may equal either 0.2 or 0.3. When x is zero, the values of x+y (i.e. the value of y) can be said to be 0.2 or 0.3.

In examples of the invention x has a value greater than 0. That is to say that the compound contains a fraction of nickel. The addition of nickel has been shown to reduce the amount of molecular oxygen that escapes that material during a charge and discharge cycle. The values of nickel and cobalt doing into the lithium-rich material can be said to be related to an overall amount. This means that the overall amount of nickel and cobalt doping is fractioned between the two metals (i.e. a value of the function of x+y). x may have a value equal to or greater than 0.175 and equal to or less than 0.275; and y has a value equal to or greater than 0.1 and equal to or less than 0.35. The value of x+y may be equal to or greater than 0.3. The values of x and y both may be greater than 0.13. More specifically, when x is 0.175, y has a value equal to or greater than 0.2 and equal to or less than 0.35; when x is 0.2, y has a value equal to or greater than 0.15 and equal to or less than 0.3; when x is 0.225, y has a value equal to or greater than 0.1 and equal to or less than 0.25; when x is 0.25, y has a value equal to or greater than 0.05 and equal to or less than 0.2, more specifically y has a value equal to or greater than 0.1 and equal to or less than 0.2; when x is 0.275, y has a value equal to or greater than 0.05 and equal to or less than 0.15, preferably y has a value equal to 0.15; when x is 0.3, y has a value equal to or greater than 0.05 and equal to or less than 0.1; and when xis 0.325, y has a value equal to 0.05. Alternatively, when y is 0.05, x has a value equal to or greater than 0.25 and equal to or less than 0.325; when y is 0.1, x has a value equal to or greater than 0.225 and equal to or less than 0.3, more specifically x has a value equal to or greater than 0.225 and equal to or less than 0.25; when y is 0.15, x has a value equal to or greater than 0.2 and equal to or less than 0.275; when y is 0.2, x has a value equal to or greater than 0.175 and equal to or less than 0.25; when y is 0.25, x has a value equal to or greater than 0.175 and equal to or less than 0.225; when y is 0.3, x has a value equal to or greater than 0.175 and equal to or less than 0.2; and when y is 0.35, x has a value equal to 0.175. A particular composition of material (i.e. Li_{1.2}Ni_{0.13}Co_{0.13}Mn_{0.54}O₂) exhibits the same benefits in improved capacity as the cobalt only series of materials (i.e. when x is equal to 0).

The compound of the present invention may be defined as having a layered structure. Typically layered structures have been shown to have the highest energy density. When in the layered form, the cobalt-only doped material can be further defined using the general formula aLi₂MnO₃.(1-a)LiCoO₂ such that a may be equal to or less than 0.88. More preferably a is equal or greater than 0.7 and equal to or less than 0.8. Specifically the material may be 0.8Li₂MnO₃.0.2LiCoO₂., or the material may be 0.7Li₂MnO₃.0.3LiCoO₂. These particular layered structures exhibit improved capacity and increased stability over a number of charge cycles.

When in the layered form, the nickel-cobalt doped material can be further defined using the general formula (1-a-b)Li₂MnO₃.aLiCoO₂.bLiNi_{0.5}Mn_{0.5}O₂ such that a is equal to or greater than 0.15 and equal to or less than 0.2; and b is 0.4. Two particular compositions of interest are a=0.2 b=0.4; and a=0.15 b=0.4. Specifically the material may be 0.45Li₂MnO₃.0.15LiCoO₂.0.4LiNi_{0.5}Mn_{0.5}O₂, or the material may be 0.4Li₂MnO₃0.2LiCoO₂.0.4LiNi_{0.5}Mn_{0.5}O₂. These particular layered structures exhibit improved capacity and increased stability over a number of charge cycles.

### BRIEF DESCRIPTION OF THE FIGURES

In order that the present invention may be more readily understood, an embodiment of the invention will now be described, by way of example, with reference to the accompanying Figures, in which:

FIG. 1 shows powder X-ray Diffraction patterns of synthesised materials in accordance with Example 1;

FIG. 2 shows first cycle galvanostatic load curves for the synthesised materials in accordance with Example 1;

FIGS. 3A-3B show additional powder X-ray Diffraction patterns of alternative synthesised materials in accordance with Example 1; and

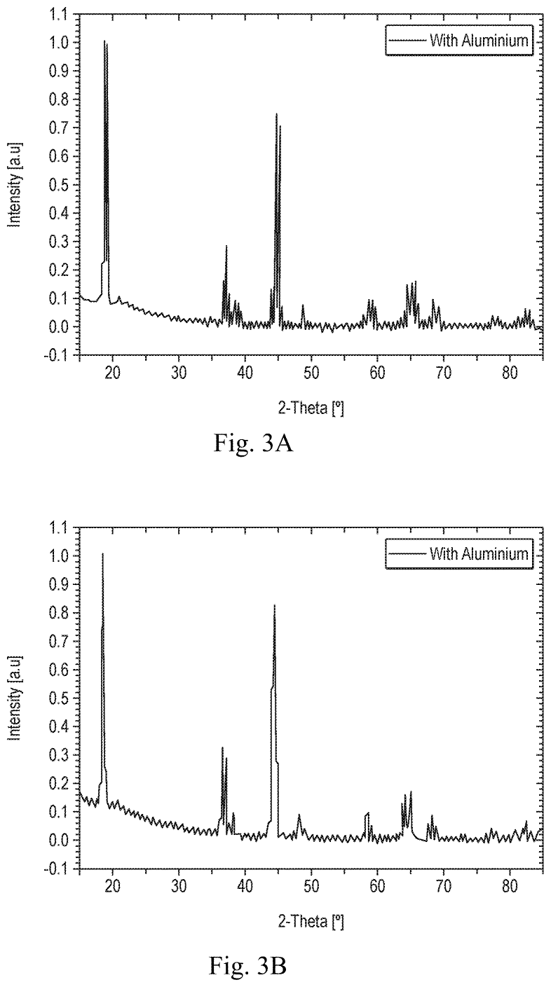

FIG. 4 shows first cycle galvanostatic load curves for alternative synthesised materials in accordance with Example 1, and capacity measurements over a number of cycles;

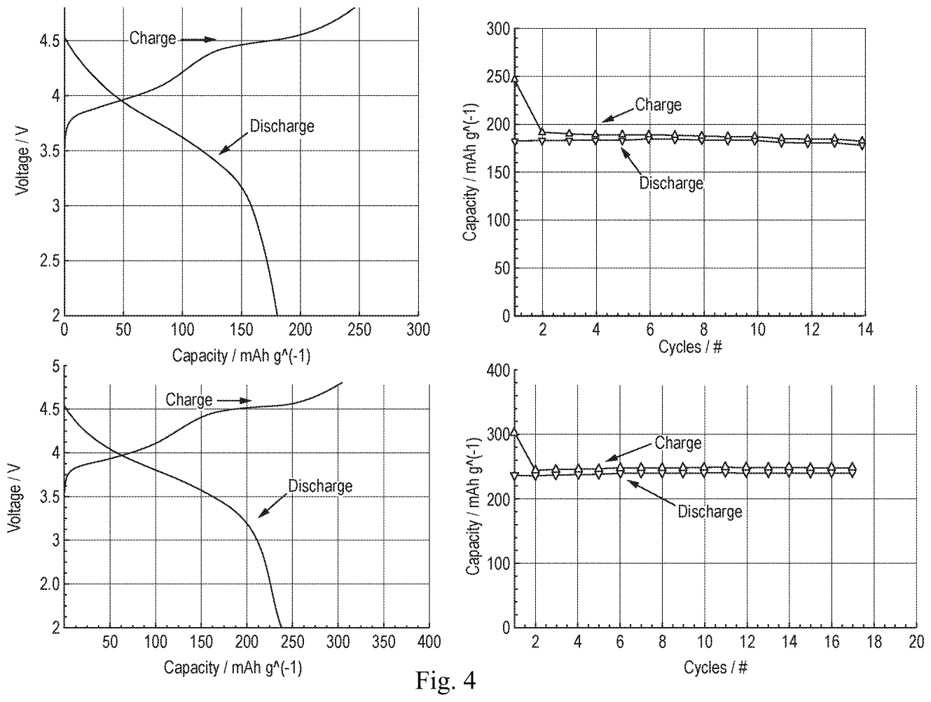

FIG. 5 shows ternary contour plots capacity and energy maps during discharge for materials of the present invention at 30° C., C/10, 2-4.8 V vs. Li/Li⁺;

FIG. 6 shows ternary contour plots capacity and energy maps during discharge for materials of the present invention at 55° C., C/10, 2-4.8 V vs. Li/Li⁺; and

FIG. 7 shows ternary contour plots gas loss maps during discharge for materials of the present invention at 30° C., C/10, 2-4.8 V vs. Li/Li⁺.

### DETAILED DESCRIPTION OF THE DISCLOSURE

The present invention will now be illustrated with reference to the following examples.

### EXAMPLE 1

### Synthesis of the Cobalt and Cobalt-Nickel Substituted Lithium Rich Materials

For material doped with cobalt only (i.e. x=0) the Formaldehyde-Resorcinol sol gel synthetic route was employed to synthesise materials with general formula

$${Li}_{( \frac{4}{3} - \frac{y}{3} )} {Co}_{y} {Mn}_{( \frac{2}{3} - \frac{2 y}{3} )} {O}_{2}$$

with y=0, 0.06, 0.12, 0.2 and 0.3 all the reagents ratios were calculated in order to obtain 0.01 mol of the final product.

Stoichiometric amounts of CH₃COOLi.2H₂O (98.0%, Sigma Aldrich (RTM)), (CH₃COO)₂Mn.4H₂O (>99.0%, Sigma Aldrich (RTM)) and (CH₃COO)₂Co.4H₂O (99.0% Sigma Aldrich (RTM)) were dissolved in 50 mL of water with 0.25 mmol of CH₃COOLi.2H₂O (99.0%, Sigma Aldrich (RTM)) corresponding to 5% moles of lithium with respect to the 0.01 moles of synthesized material. At the same time 0.1 mol of resorcinol (99.0%, Sigma Aldrich (RTM)) was dissolved in 0.15 mol of formaldehyde (36.5% w/w solution in water, Fluka (RTM)). Once all the reagents were completely dissolved in their respective solvents, the two solutions were mixed and the mixture was vigorously stirred for one hour. The resulting solution, containing 5% molar excess of lithium, was subsequently heated in an oil bath at 80° C. until the formation of a homogeneous white gel.

The gel was finally dried at 90° C. overnight and then heat treated at 500° C. for 15 hours and 800° C. for 20 hours.

For material doped with cobalt-nickel, The Formaldehyde-Resorcinol sol gel synthetic route was employed to synthesise materials with general formula

$${Li}_{( \frac{4}{3} - \frac{2 x}{3} - \frac{y}{3} )} {Co}_{y} {Ni}_{x} {Mn}_{( \frac{2}{3} - \frac{x}{3} - \frac{2 y}{3} )} {O}_{2}$$

where x=0.2 y=0.15. All the reagents ratios were calculated in order to obtain 0.01 mol of the final product.

Stoichiometric amounts of CH₃COOLi.2H₂O (98.0%, Sigma Aldrich (RTM)), (CH₃COO)₂Mn.4H₂O (>99.0%, Sigma Aldrich (RTM)) (CH₃COO)₂Ni.4H₂O (99.0% Sigma Aldrich (RTM) and (CH₃COO)₂Co.4H₂O (99.0% Sigma Aldrich (RTM)) were dissolved in 50 mL of water with 0.25 mmol of CH₃COOLi.2H₂O (99.0%, Sigma Aldrich (RTM)) corresponding to 5% moles of lithium with respect to the 0.01 moles of synthesized material. At the same time 0.1 mol of resorcinol (99.0%, Sigma Aldrich (RTM)) was dissolved in 0.15 mol of formaldehyde (36.5% w/w solution in water, Fluka (RTM)). Once all the reagents were completely dissolved in their respective solvents, the two solutions were mixed and the mixture was vigorously stirred for one hour. The resulting solution, containing 5% molar excess of lithium, was subsequently heated in an oil bath at 80° C. until the formation of a homogeneous white gel.

The gel was finally dried at 90° C. overnight and then heat treated at 500° C. for 15 hours and 800° C. for 20 hours.

### EXAMPLE 2

### Structural Analysis and Characterisation of the Cobalt and Cobalt-Nickel Substituted Lithium Rich Materials

The materials according to Example 1 were examined with Powder X-Ray Diffraction (PXRD) which was carried out utilising a Rigaku (RTM) SmartLab equipped with a 9 kW Cu rotating anode.

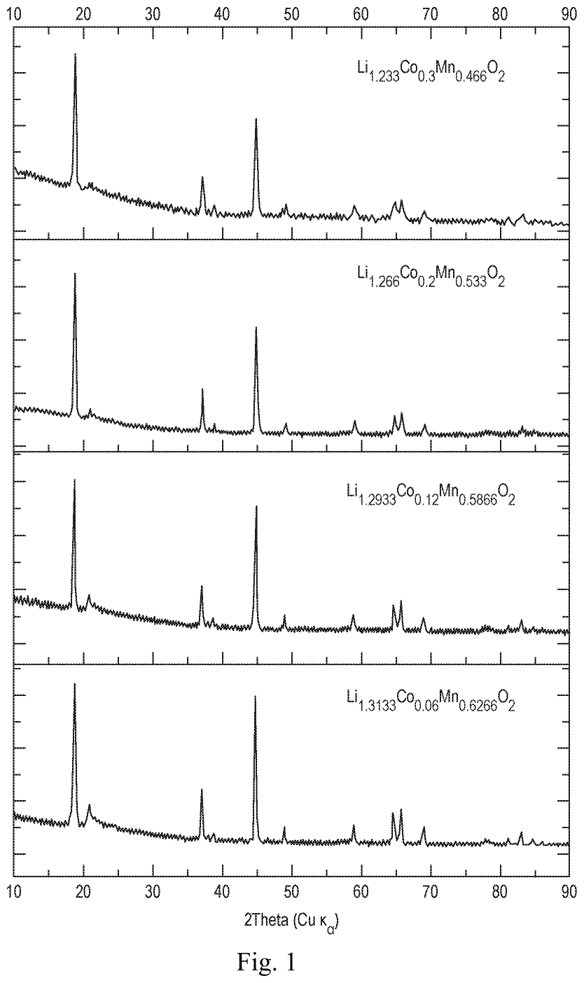

FIGS. 1 (cobalt doped) and 3A and 3B (nickel-cobalt doped compositions 1 and 2, respectively) show Powder X-ray Diffraction patterns of the synthesized materials. These are characteristic of layered materials with some cation ordering in the transition layer. All of the patterns appear to show the major peaks consistent with a close-packed layered structure such as LiTMO₂ with a R-3m space group. Additional peaks are observed in the range 20-30 2Theta degrees which cannot be assigned to the R-3m space. The order derives from the atomic radii and charge density differences between Li⁺(0.59 Å), Ni⁺² (0.69 Å) and Mn⁴⁺ (0.83 Å) and appears the strongest in the structures of the low nickel doped oxides. The peaks are not as strong as in materials where a perfect order exists as in Li₂MnO₃. No presence of extra-peaks due to impurities was observed.

### EXAMPLE 3

### Electrochemical Analysis of the Cobalt and Cobalt-Nickel Substituted Lithium Rich Materials

The materials according to Example 1 were characterised electrochemically through galvanostatic cycling performed with a BioLogic VMP3 and a Maccor 4600 series potentiostats. All the samples were assembled into stainless steel coincells against metallic lithium and cycled between 2 and 4.8 V vs. Li⁺/Li for 100 cycles at a current rate of 50 mAg⁻¹. The electrolyte employed was LP30 (a 1M solution of LiPF₆ in 1;1 w/w ratio of EC;DMC).

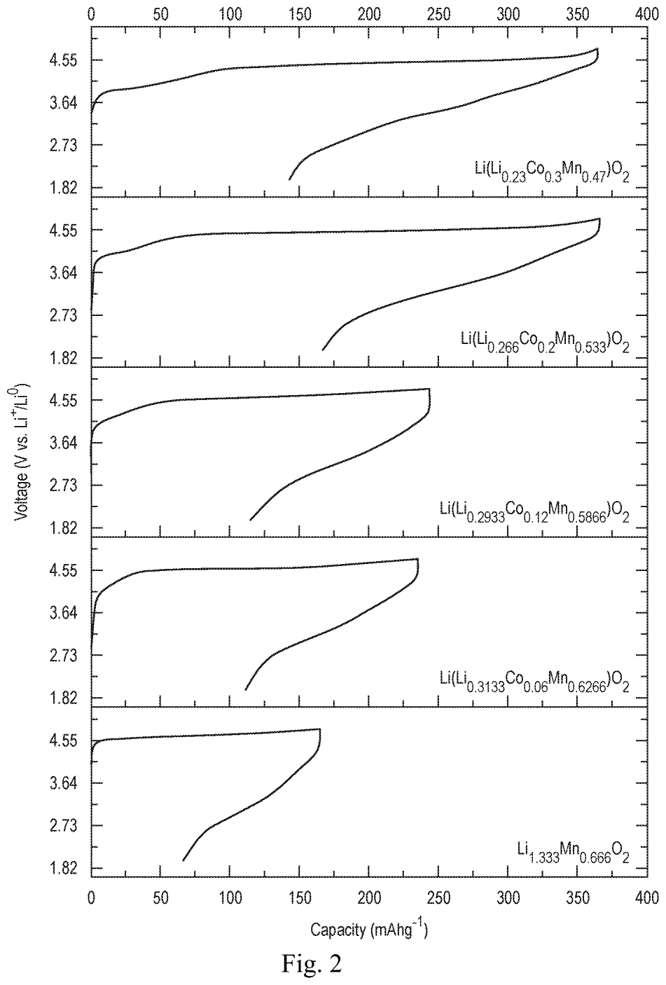

FIGS. 2 (cobalt doped) and 4 (nickel-cobalt doped compositions 1 and 2, respectively) show the potential curves during the charge and subsequent discharge of the first cycle for materials according to Example 1. Both samples present a high voltage plateau of different lengths centered on 4.5 V vs. Li⁺/Li⁰, and a sloped region at the beginning of the charge. The length of this region may be attributed to the oxidation of nickel from Ni⁺² toward Ni⁺⁴ and Co⁺³ toward Co⁺⁴ and appears to be in good agreement with the amount of lithium (i.e. charge) that would be extracted accounting for solely the transition metal redox activity.

During the first discharge, neither material shows the presence of a reversible plateau, indicating a difference in the thermodynamic pathways followed during the extraction (charge) and insertion (discharge) of lithium ions from/in the lattice of each sample.

For the materials of Example 1 the first cycle presents the lowest coulombic efficiency value due to the presence of the high potential plateau which is not reversible. The coulombic efficiencies appear to quickly improve from the first cycle values, around 60-80%, to values higher than 98% within the first five cycles.

Compositions demonstrating the technical benefits in accordance with the Examples and the present invention are detailed below.

| Compo- | | | | | |
|---|---|---|---|---|---|
| sition | Li | Mn | Co | Ni | O |
| 1 | 1.15 | 0.55 | 0.05 | 0.25 | 2 |
| 2 | 1.15 | 0.525 | 0.1 | 0.225 | 2 |
| 3 | 1.15 | 0.5 | 0.15 | 0.2 | 2 |
| 4 | 1.15 | 0.475 | 0.2 | 0.175 | 2 |
| 5 | 1.133333 | 0.541667 | 0.05 | 0.275 | 2 |
| 6 | 1.133333 | 0.516667 | 0.1 | 0.25 | 2 |
| 7 | 1.133333 | 0.491667 | 0.15 | 0.225 | 2 |
| 8 | 1.133333 | 0.466667 | 0.2 | 0.2 | 2 |
| 9 | 1.133333 | 0.441667 | 0.25 | 0.175 | 2 |
| 10 | 1.116667 | 0.533333 | 0.05 | 0.3 | 2 |
| 11 | 1.116667 | 0.508333 | 0.1 | 0.275 | 2 |
| 12 | 1.116667 | 0.483333 | 0.15 | 0.25 | 2 |
| 13 | 1.116667 | 0.458333 | 0.2 | 0.225 | 2 |
| 14 | 1.116667 | 0.433333 | 0.25 | 0.2 | 2 |
| 15 | 1.116667 | 0.408333 | 0.3 | 0.175 | 2 |
| 16 | 1.1 | 0.525 | 0.05 | 0.325 | 2 |
| 17 | 1.1 | 0.5 | 0.1 | 0.3 | 2 |
| 18 | 1.1 | 0.475 | 0.15 | 0.275 | 2 |
| 19 | 1.1 | 0.45 | 0.2 | 0.25 | 2 |
| 20 | 1.1 | 0.425 | 0.25 | 0.225 | 2 |
| 21 | 1.1 | 0.4 | 0.3 | 0.2 | 2 |
| 22 | 1.1 | 0.375 | 0.35 | 0.175 | 2 |

Compositions demonstrating higher levels of the technical benefits in accordance with the Examples and the present invention are detailed below.

| Compo- | | | | | |
|---|---|---|---|---|---|
| sition | Li | Mn | Co | Ni | O |
| 1 | 1.15 | 0.525 | 0.1 | 0.225 | 2 |
| 2 | 1.15 | 0.5 | 0.15 | 0.2 | 2 |
| 3 | 1.15 | 0.475 | 0.2 | 0.175 | 2 |
| 4 | 1.133333 | 0.516667 | 0.1 | 0.25 | 2 |
| 5 | 1.133333 | 0.491667 | 0.15 | 0.225 | 2 |
| 6 | 1.133333 | 0.466667 | 0.2 | 0.2 | 2 |
| 7 | 1.133333 | 0.441667 | 0.25 | 0.175 | 2 |
| 8 | 1.116667 | 0.483333 | 0.15 | 0.25 | 2 |
| 9 | 1.116667 | 0.458333 | 0.2 | 0.225 | 2 |
| 10 | 1.116667 | 0.433333 | 0.25 | 0.2 | 2 |
| 11 | 1.116667 | 0.408333 | 0.3 | 0.175 | 2 |
| 12 | 1.1 | 0.475 | 0.15 | 0.275 | 2 |
| 13 | 1.1 | 0.45 | 0.2 | 0.25 | 2 |
| 14 | 1.1 | 0.425 | 0.25 | 0.225 | 2 |
| 15 | 1.1 | 0.4 | 0.3 | 0.2 | 2 |
| 16 | 1.1 | 0.375 | 0.35 | 0.175 | 2 |

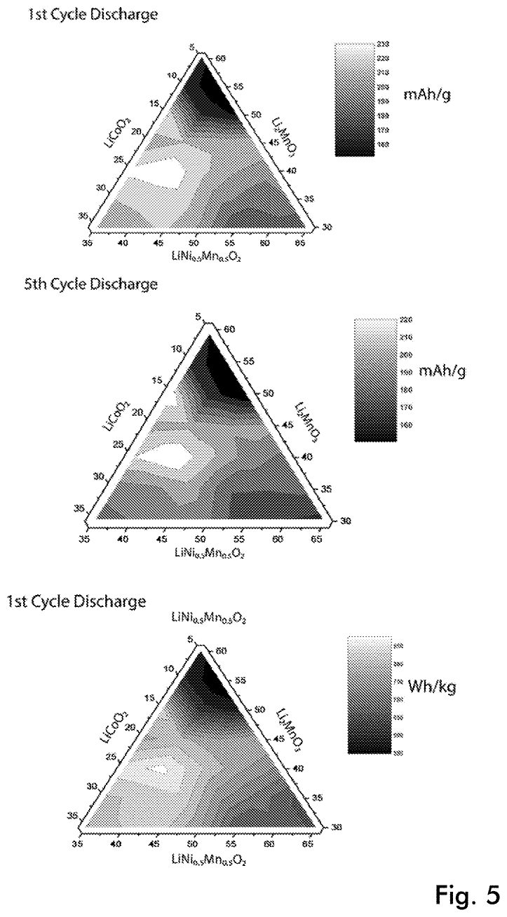

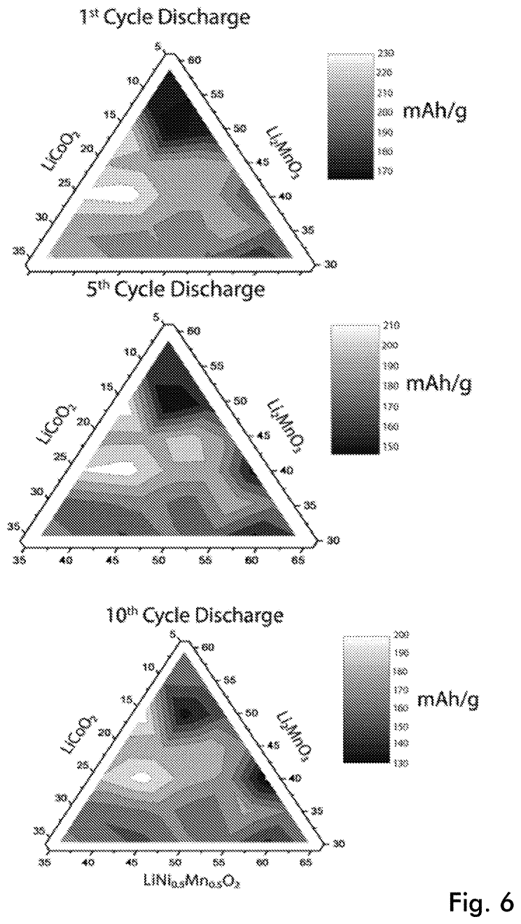

These materials were tested in accordance with the method above, and the results are shown in FIGS. 5 and 6 as ternary contour plots capacity and energy maps during discharge for materials of the present invention at 30° C. and 55° C. C/10, 2-4.8 V vs. Li/Li⁺.

### EXAMPLE 4

### Gas Evolution During the First Cycle of the Nickel-Cobalt Substituted Lithium Rich Materials

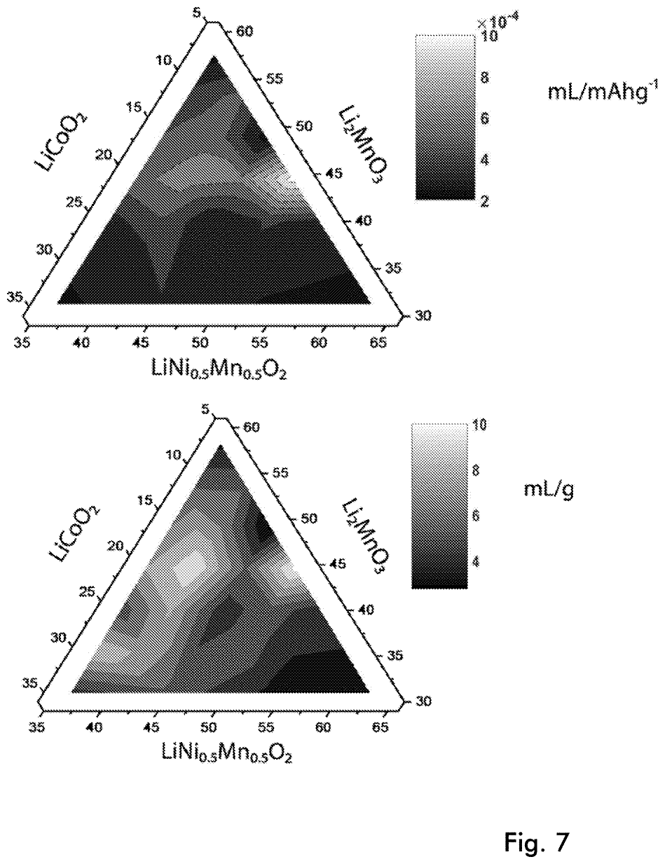

One pellet of each material according to the present invention was assembled into a EL-Cell PAT-Cell-Press (RTM) single cell. All the samples were assembled versus metallic lithium and cycled from OCV to 4.8 V vs. Li+/Li and then discharged to 2V at a current rate of 50 mAg-1. The electrolyte employed was LP30 (a 1M solution of LiPF6 in 1;1 w/w ratio of EC;DMC). This cell was specifically designed to record the pressure changes within the headspace, this could then be related to the mols of gas evolved from the cathode. The pressure sensor in the cell was connected via a controller box which was linked to a computer via a USB link. This was then logged via the Datalogger and EC-Link Software provided by EL-Cell (RTM). The data was logged as Voltage, Current, time and pressure. These values could be combined through the ideal gas law to calculate the number of mols of gas evolved on cycling which could be used to calculate the volume of gas evolved under ambient conditions. The total gas loss for each material during charge was calculated and a contour plot generated as FIG. 7 which shows gas loss as a function of composition within the ternary space.

1. A method comprising:
increasing a charge capacity of a cathode material by incorporating cobalt in a lithium rich cathode material of the general formula:
$${Li}_{( \frac{4}{3} - \frac{2 x}{3} - \frac{y}{3} )} {Ni}_{x} {Co}_{y} {Mn}_{( \frac{2}{3} - \frac{x}{3} - \frac{2 y}{3} )} {O}_{2}$$

2. The method of claim 1, wherein x has a value equal to or greater than 0.175 and equal to or less than 0.275; and y has a value equal to or greater than 0.1 and equal to or less than 0.35

3. The method of claim 2, wherein the value of x+y is equal to or greater than 0.3.

4. The method of claim 2, wherein x and y both are greater than 0.13.

518. (canceled)

19. The method of claim 1, wherein the cathode material has a layered structure.

20. The method of claim 19, wherein the layered structure is expressed as the general formula:
(1-a-b)Li₂MnO₃.aLiCoO₂.bLiNi_{0.5}Mn_{0.5}O₂
wherein a=y and b=2x; and
a is equal to or greater than 0.15 and equal to or less than 0.2; and
b is 0.4.

21. The method of claim 20, wherein the material is 0.45Li₂MnO₃.0.15LiCoO₂.0.4LiNi_{0.5}Mn_{0.5}O₂.

22. The method of claim 20, wherein the material is 0.4Li₂MnO₃.0.2LiCoO₂.0.4LiNi_{0.5}Mn_{0.5}O₂.

23. A method comprising:
increasing the charge capacity of a cathode material by incorporating cobalt in a lithium rich cathode material of the general formula:
$${Li}_{( \frac{4}{3} - \frac{y}{3} )} {Co}_{y} {Mn}_{( \frac{2}{3} - \frac{2 y}{3} )} {O}_{2}$$
wherein y has a value greater than 0.12 and equal to or less than 0.4.

24. The method of claim 23, wherein y has a value of equal to or greater than 0.2 and equal to or less than 0.3.

25. The method of claim 23, wherein y is equal to 0.2.

26. The method of claim 23, wherein y is equal to 0.3.

27. The method of claim 23, wherein the compound is a cathode material having a layered structure.

28. The method of claim 27, wherein the layered structure is expressed as the general formula:
aLi₂MnO₃.(1-a)LiCoO₂
wherein a=y; and
a is less than 0.88.

29. The method of claim 26, wherein a is equal or greater than 0.7 and equal to or less than 0.8.

30. The method of claim 26, wherein the material is 0.8Li₂MnO₃.0.2LiCoO₂.

31. The method of claim 26, wherein the material is 0.7Li₂MnO₃.0.3LiCoO₂.

32. A method comprising:
suppressing gas evolution from a cathode material during a charge cycle by incorporating cobalt in a lithium rich cathode material of the general formula:
$${Li}_{( \frac{4}{3} - \frac{2 x}{3} - \frac{y}{3} )} {Ni}_{x} {Co}_{y} {Mn}_{( \frac{2}{3} - \frac{x}{3} - \frac{2 y}{3} )} {O}_{2}$$

33. The method of claim 32, wherein the gas is molecular oxygen and/or carbon dioxide.

34. The method of claim 32, wherein x has a value equal to or greater than 0.175 and equal to or less than 0.275; and y has a value equal to or greater than 0.1 and equal to or less than 0.35

35. The method of claim 34, wherein the value of x+y is equal to or greater than 0.3.

36. The method of claim 34, wherein x and y both are greater than 0.13.

37-49. (canceled)

50. The method of claim 34, wherein when y is 0.35, x has a value equal to 0.175.

51. The method of claim 32, wherein the cathode material has a layered structure.

52. The method of claim 51, wherein the layered structure is expressed as the general formula:
(1-a-b)Li₂MnO₃.aLiCoO₂.bLiNi_{0.5}Mn_{0.5}O2
wherein a=y and b=2x; and
a is equal to or greater than 0.15 and equal to or less than 0.2; and
b is 0.4.

53. The method of claim 52, wherein the material is 0.45Li₂MnO₃.0.15LiCoO₀.0.4LiNi_{0.5}Mn_{0.5}O₂.

54. The method of claim 52, wherein the material is 0.4Li₂MnO₃.0.2LiCoO₂.0.4LiNi_{0.5}Mn_{0.5}O₂.
